(19) United States
(12) Patent Application Publication
(10) Pub. No.: US 2004/0156695 A1
(43) Pub. Date: Aug. 12, 2004

(54) Nut with fitting piece projecting outwardly from an attachment part

(76) Inventor: Kaoru Taneichi, Atsugi-shi (JP)

Correspondence Address: JORDAN AND HAMBURG LLP, 122 EAST 42ND STREET, SUITE 4000, NEW YORK, NY, 10168, US

(21) Appl. No.: 10/764,665

(22) Filed: Jan. 26, 2004

Related U.S. Application Data
(63) Continuation of application No. 09/898,820, filed on Jul. 3, 2001.

(30) Foreign Application Priority Data
Sep. 25, 2000 (JP) 2000-289930

(51) Int. Cl. F16B 39/36

(52) U.S. Cl. 411/267

(57) ABSTRACT

A nut including a nut body having a polygonal outer wall and an inner wall defining the through hole being an inclined wall hole; a stopper formed as a stop flange; at least two guideposts formed coaxially on the inner wall of the nut body at the inclined wall hole; a spring disposed in the nut body between the stop flange and the at least three nut segments to bias the at least three nut segments toward the second end of the nut body; the nut body including an attachment part provided adjacent said second end, one of the attachment part with a fitting piece in order to attach rotatably and prevent to remove fixedly to a member with an axle hole and another attachment part attached to the attachment member by one of screwing and pressure.

### REFERENCE TO RELATED APPLICATION

This is a Continuation application and hereby incorporates by reference the entire disclosure of application Ser. No. 09/898,820, filed Jul. 3, 2001.

### BACKGROUND OF THE INVENTION

The present invention is related to a nut that can use attachment member as a washer.

By pushing into a bolt, the conventional nut which can move to a predetermined position and is divided into a plurality of thread parts screws with the screw thread of the bolt by rotating has the washer attached rotatably itself, the washer allowing the nut provide to the attachment member.

The conventional kind of nut has a complicated structure, required trouble for attachment, had to use the washer with which form is different according to a use portion, and had the fault that manufacture was troublesome and became cost quantity.

### SUMMARY OF THE INVENTION

Accordingly, it is an object of the present invention to provide a nut wherein its structure is simple and allow attaching easily. It is another object of the present invention to provide a nut that the attachment member can be used as a washer and can be manufactured at low cost.

The novel features which are believed to be characteristic of the invention, both as to its organization and method of operation, together with further objects and advantages thereof, are described below with reference to the accompanying drawings in which a presently preferred embodiment of the invention is illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is an explanation view in use showing a first embodiment of the present invention;

FIG. 2 is a front view in use showing the first embodiment of the present invention;

FIG. 3 is a front view showing the first embodiment of the present invention;

FIG. 4 is a bottom view showing the first embodiment of the present invention;

FIG. 5 is a flat view showing the first embodiment of the present invention;

FIG. 6 is a cross sectional view taken along a line 6 6 of FIG. 1;

FIG. 7 is an explanation view showing the nut mounted;

FIG. 8 is an explanation view showing movement of the nut;

FIG. 9 is a front view showing a second embodiment of the present invention;

FIG. 10 is a bottom view showing the second embodiment of the present invention;

FIG. 11 is a longitudinal cross-sectional view showing the second embodiment of the present invention;

FIG. 12 is a front view showing a third embodiment of the present invention;

FIG. 13 is a bottom view showing the third embodiment of the present invention;

FIG. 14 is a longitudinal cross-sectional view showing the third second embodiment of the present invention;

FIG. 15 is an explanation view showing the nut member;

FIG. 16 is a front view showing a fourth embodiment of the present invention;

FIG. 17 is a bottom view showing the fourth embodiment of the present invention;

FIG. 18 is a longitudinal cross-sectional view showing the fourth second embodiment of the present invention;

FIG. 19 is a front view showing a fifth embodiment of the present invention;

FIG. 20 is a bottom view showing the fifth embodiment of the present invention;

FIG. 21 is a longitudinal cross-sectional view showing the fifth embodiment of the present invention;

FIG. 22 is a bottom view showing a sixth embodiment of the present invention;

FIG. 23 is a longitudinal cross-sectional view showing the sixth embodiment of the present invention;

FIG. 24 is an explanation view showing the nut member;

FIG. 25 is a bottom view showing a seventh embodiment of the present invention;

FIG. 26 is a longitudinal cross-sectional view showing the seventh embodiment of the present invention;

FIG. 27 is an explanation view showing the nut member;

FIG. 28 is a front view showing an eighth embodiment of the present invention;

FIG. 29 is a bottom view showing the eighth embodiment of the present invention;

FIG. 30 is a longitudinal cross-sectional view showing the eighth embodiment of the present invention;

FIG. 31 is a front view showing a ninth embodiment of the present invention;

FIG. 32 is a bottom view showing the ninth embodiment of the present invention;

FIG. 33 is a longitudinal cross-sectional view showing the ninth embodiment of the present invention;

FIG. 34 is a front view showing a tenth embodiment of the present invention;

FIG. 35 is a bottom view showing the tenth embodiment of the present invention;

FIG. 36 is a longitudinal cross-sectional view showing the tenth embodiment of the present invention;

FIG. 37 is a front view showing an eleventh embodiment of the present invention;

FIG. 38 is a bottom view showing the eleventh embodiment of the present invention;

FIG. 39 is a longitudinal cross-sectional view showing the eleventh embodiment of the present invention;

FIG. 40 is a front view showing a twelfth embodiment of the present invention;

FIG. 41 is a bottom view showing the twelfth embodiment of the present invention;

FIG. 42 is a longitudinal cross-sectional view showing the twelfth embodiment of the present invention;

FIG. 43 is a front view showing a thirteenth embodiment of the present invention;

FIG. 44 is a bottom view showing the thirteenth embodiment of the present invention; and

FIG. 45 is a longitudinal cross-sectional view showing the thirteenth embodiment of the present invention.

### DETAILED DESCRIPTION

Preferred embodiments of the present invention are described in more detail below referring to the accompanying drawings.

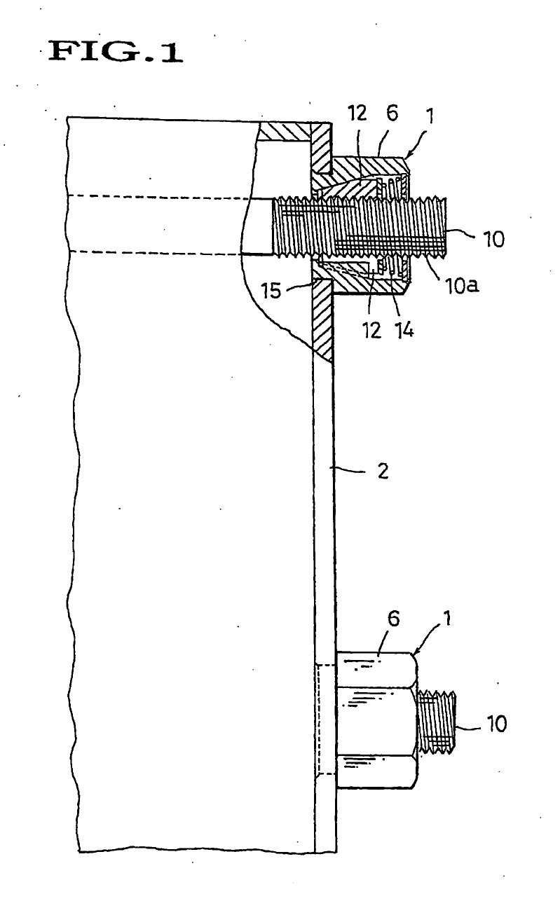

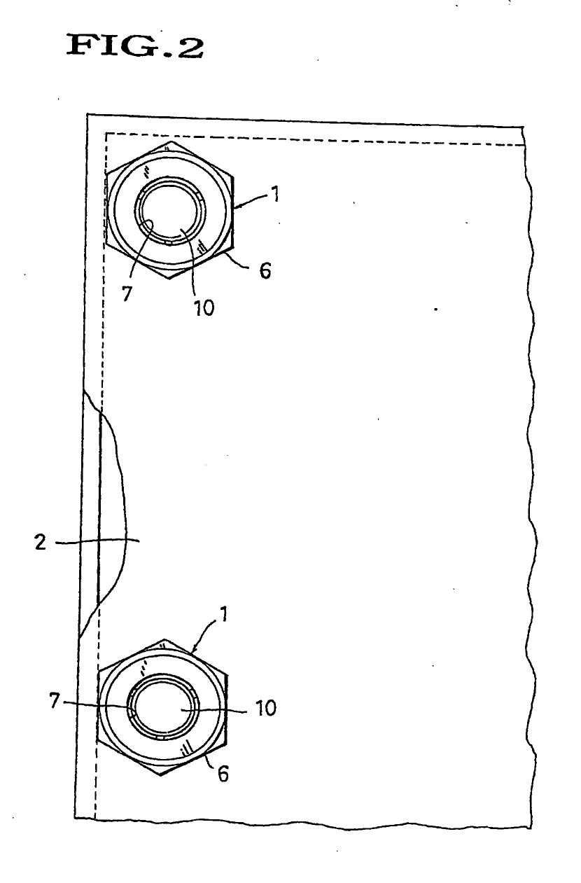

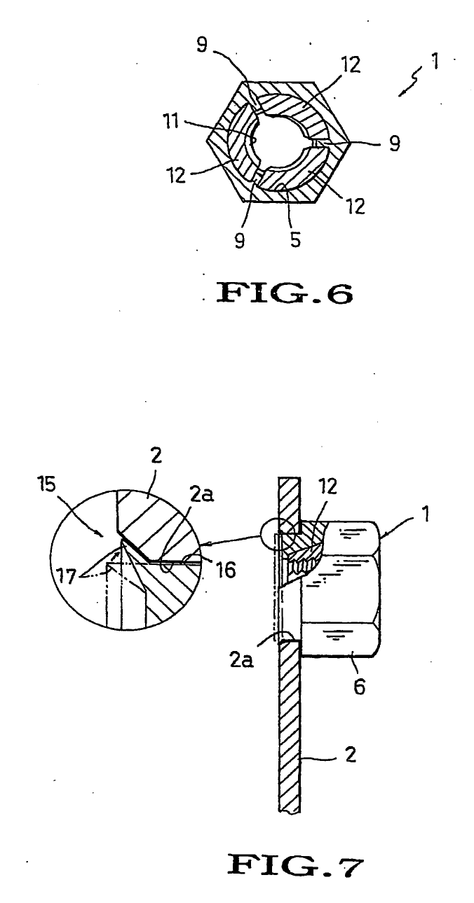

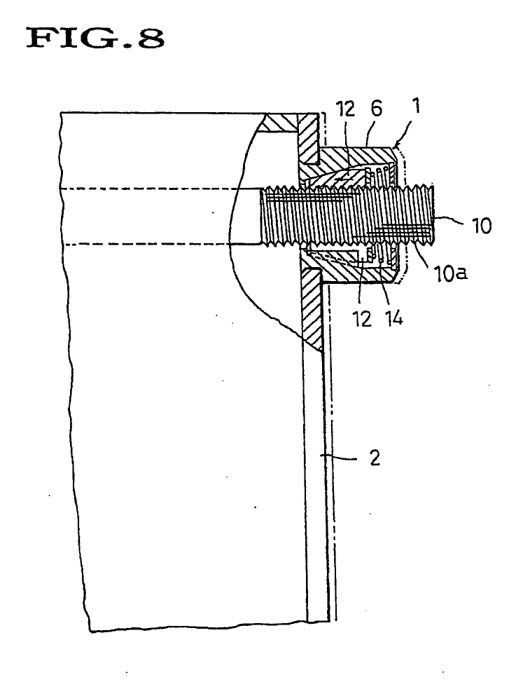

An understanding of the present invention may be best gained by reference FIGS. 1 to 8. FIGS. 1 to 8 illustrate a first embodiment of the present invention wherein a nut 1, for example shown in FIG. 1, is used as a washer the attachment member 2 which is the parts of apparatus.

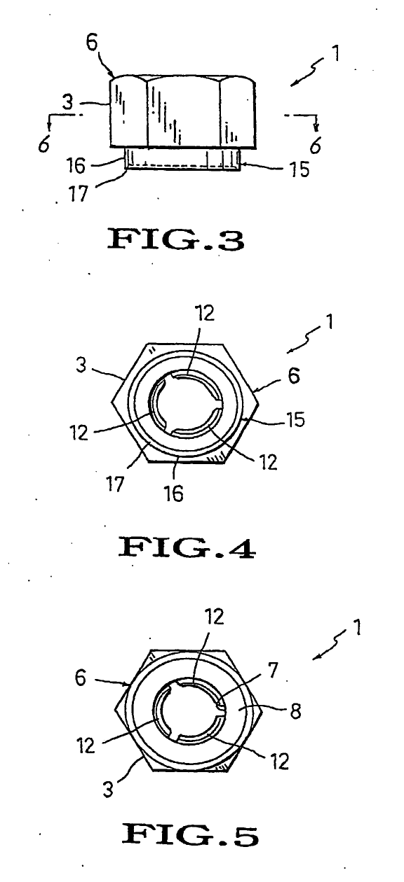

Referring to FIGS. 3 to 6, the nut 1 has an outer wall 3 formed in the shape of a polygon, for example, a hexagonal shape in each embodiment of the present invention and an inner wall 4 defining a portion of a through hole. The nut 1 comprises a nut body 6 with the through hole having an inclined hole portion with an inclined inner wall extending from a small diameter end of the nut body 6 to a large diameter end at the inner wall 4. A stopper 8 is formed at an end portion of the through hole at the large diameter and defines a bolt insertion hole 7. At least two or more guideposts, for example three guideposts 9 in this embodiment, are formed coaxially at the inclined inner wall of the nut body 6. Three nut segments 12 are movably disposed among the guideposts 9 to move in a coaxial direction and have screw threads 11 on an inner wall thereof. The screw threads 11 screw onto the bolt 10. A spring 14 is located within the nut body 6, having one end thereof contacts to a flange 13 provided at an end of the nut segments 12 as necessary and another end thereof contacts to the stopper 8. The spring is located to bias the nut segments 12 toward the short diameter end of the nut body 6. A fitting part 15 is formed at an end portion of the through hole at a small diameter, providing rotatably to the end of the insertion hole 2a of the attachment member 2.

The three nut segments 12 are formed so that a portion adjacent the spring 14 is thicker than a portion adjacent the nut body 6.

The attachment part 15 comprises a support axle 16 formed at an end portion of the through hole at a small diameter, having a small diameter rather than the outer diameter of the nut body 6 and a fitting piece 17 formed at an outer circumferential portion of the support axle 16.

In the above-mentioned nut 1, after the support axle 16 is inserted into the insertion hole 2a of the attachment member 2 which is the parts of apparatus, the nut 1 is fixed rotatably by fitting the fitting piece 17 such that it protect to remove the nut 1.

After that, the bolt 10 is pushed into the nut 1 to a predetermined position, and the nut segments 12 of the nut 1 screwed onto the thread portion 10a of the bolt 10 by rotating the nut 1 in the direction of bolting, and the nut 1 is tightened as the conventional nut.

Moreover, since the nut 1 is fixed to the attachment member 2 when the bolt 10 extends or contraction occurs, it moves with the attachment member 2 together, and the nut segments 12 slides due to the spring power of the spring 14 in the direction of tightening and prevents loss of tightening power automatically.

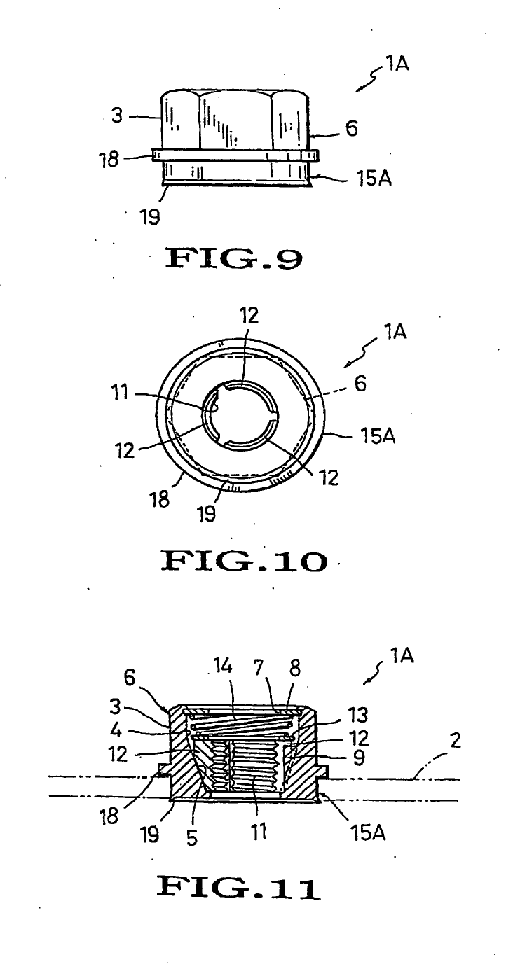

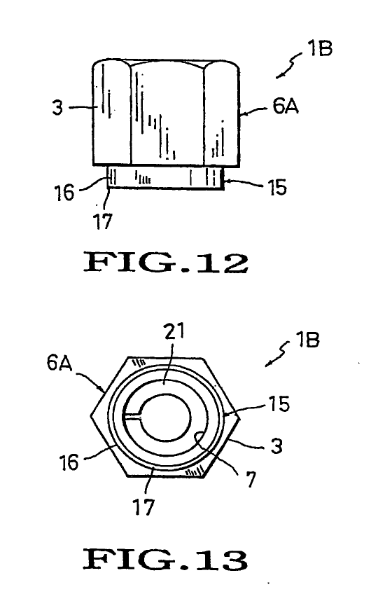

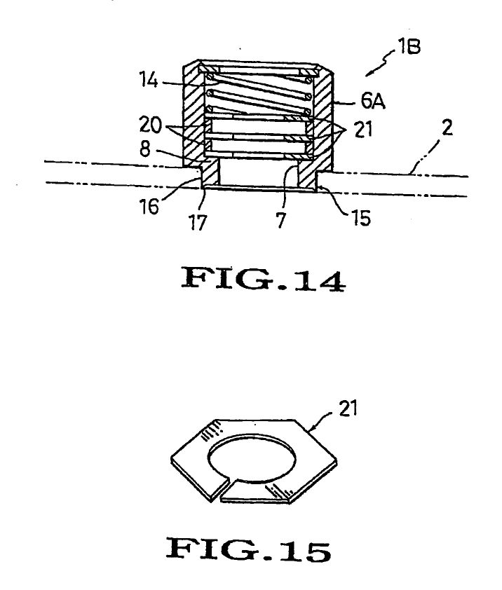

Other embodiments of the present invention will now be described referring to FIGS. 9 to 45. Through the drawings of the embodiments, like components are denoted by like numerals as of the first embodiment and will not be further explained in great detail.

A second embodiment of the present invention is shown in FIGS. 9 to 11. It is distinguished from the first embodiment by the fact that the attachment part 15 is replaced with another similar attachment part 15A. The attachment part 15A includes a support piece 18 formed in the shape of a flange, providing at an outer circumferential portion at the small diameter of the nut body 6 and a fitting piece 19 provided at an outer circumferential portion at the small diameter of the nut body 6. A nut 1A with the attachment part 15A according to the second embodiment has similar advantages to that according to the first embodiment.

A third embodiment of the present invention is shown in FIGS. 12 to 15. It is distinguished from the first embodiment by the fact that the nut 1 is replaced with another similar nut 1B. The nut 1B includes a nut body 6A formed in the shape of a polygon, for example, a hexagonal and tubular shape in the embodiment of the present invention; stopper 8 with the bolt insertion hole 7 is formed at an end portion of the nut body 6A, the insertion hole 7 having the small diameter rather than the inner diameter of the nut body; a plurality of nut members 21 formed in the shape of a hexagonal, for example, washer shape in the embodiment of the present invention, installing into the nut body 6A through a spacer 20 formed in the shape of a ring such that the nut members is prevented to fall down and rotate by fitting another end portion of the nut body 6A, cut a portion gears with rod, variant steel rod and the like; and a spring 14 located within the nut body 6 and located to bias the nut members 21 toward an end portion. A nut 1B in this way according to the second embodiment has similar advantages to that according to the first embodiment.

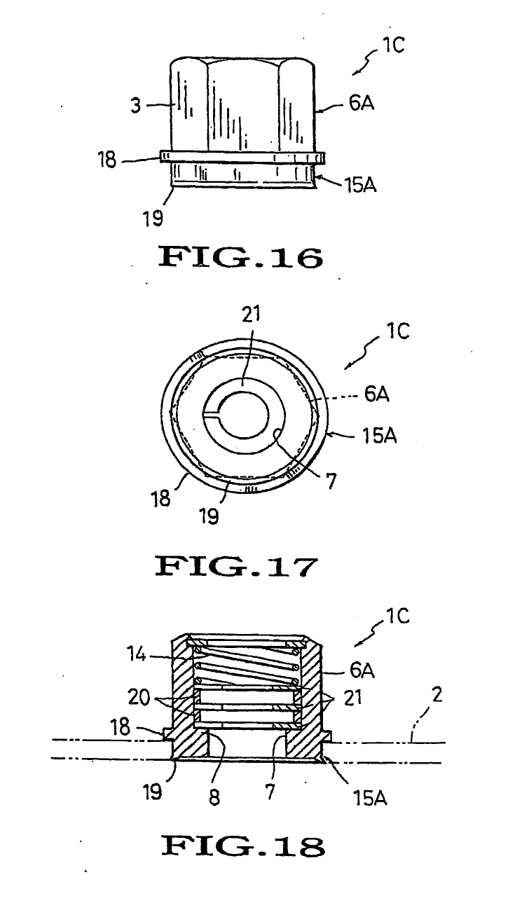

A fourth embodiment of the present invention is shown in FIGS. 16 to 18. It is distinguished from the third embodiment by the fact that the attachment part 15A is formed in the outer circumferential portion of the end of the nut body 6A. A nut 1C in this way according to the fourth embodiment has similar advantages to that according to the third embodiment.

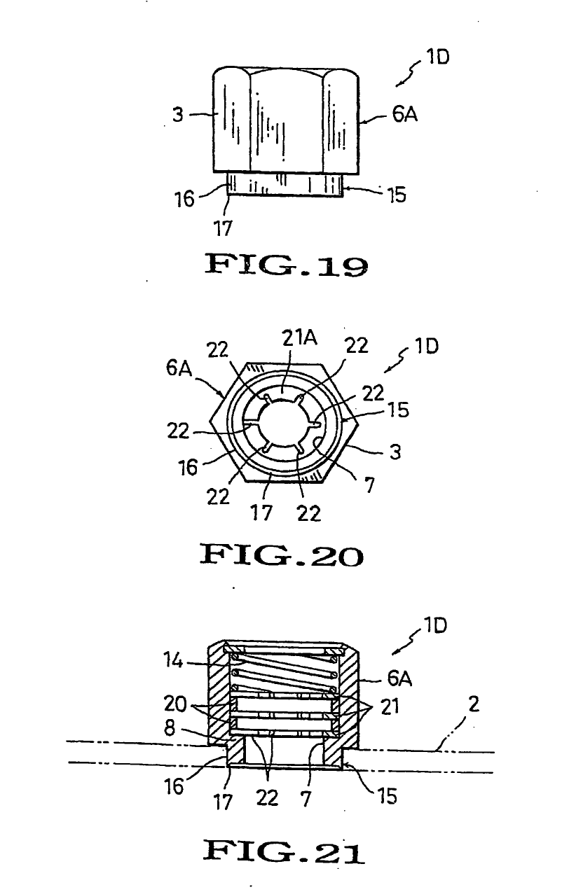

A fifth embodiment of the present invention is shown in FIGS. 19 to 21. It is distinguished from the third embodiment by the fact that the nut members 21 are replaced with another similar nut members 21A. The nut members 21A have a plurality of cutting parts, six cutting parts 22 in the embodiment of the present invention respectively. A nut 1D with the nut members 21A according to the fifth embodiment has similar advantages to that according to the third embodiment.

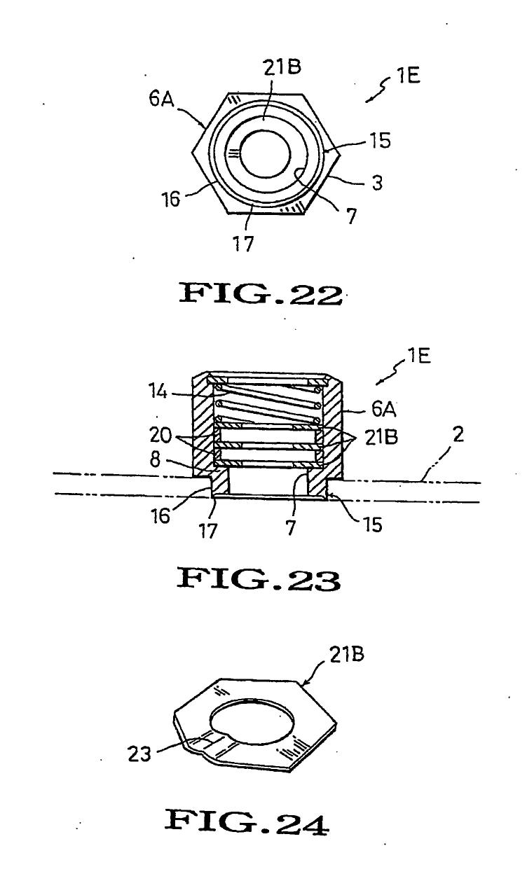

A sixth embodiment of the present invention is shown in FIGS. 22 to 24. It is distinguished from the third embodiment by the fact that the nut members 21 are replaced with another similar nut members 21B. The nut members 21B have protrusions 23 formed at a portion thereof without cutting. A nut 1E with the nut members 21B according to the sixth embodiment has similar advantages to that according to the third embodiment.

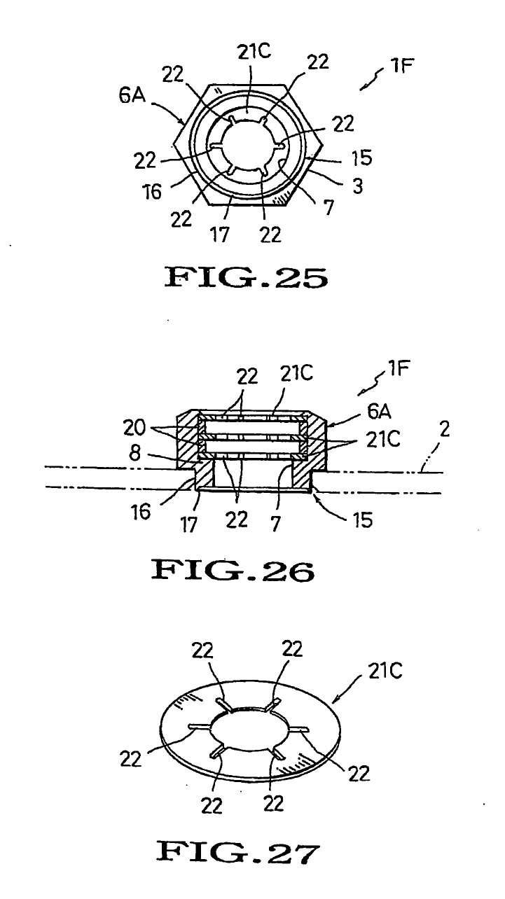

A seventh embodiment of the present invention is shown in FIGS. 25 to 27. It is distinguished from the fifth embodiment by the fact that the nut members 21A are replaced with another similar nut members 21C. The nut member 21C is formed in the shape of a circle at an outer circumferential portion thereof without using the spring. A nut 1F with the nut members 21C can be pushed onto a bolt, variant steel rod, rod and so on and can be used as a fixed implement fixed in a predetermined position.

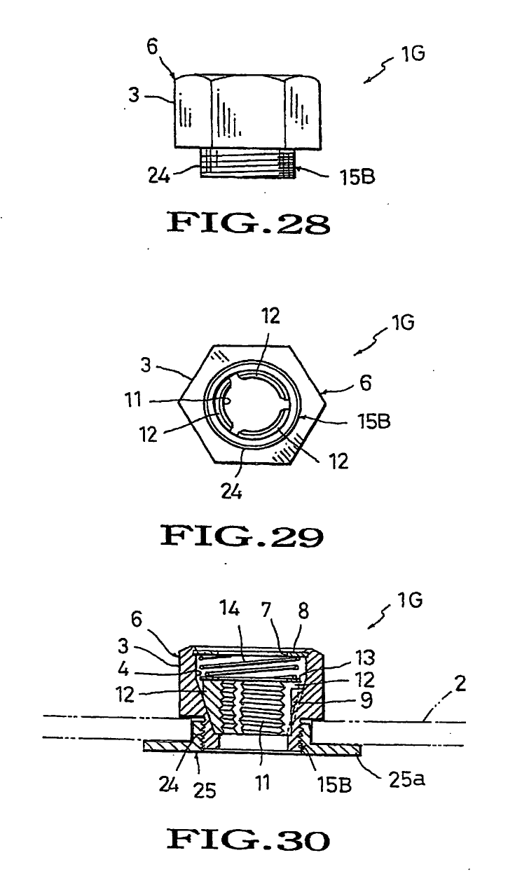

An eighth embodiment of the present invention is shown in FIGS. 28 to 30. It is distinguished from the first embodiment by the fact that the attachment part 15 is replaced from another similar attachment part 15B. The attachment part 15B has a thread portion 24 provided at an outer circumferential portion thereof. The thread portion 24 of the attachment portion is screwed onto a mounting member 25, having a flange 25a, formed in the shape of a nut. A nut 1G in this way according to the eighth embodiment has similar advantages to that according to the first embodiment.

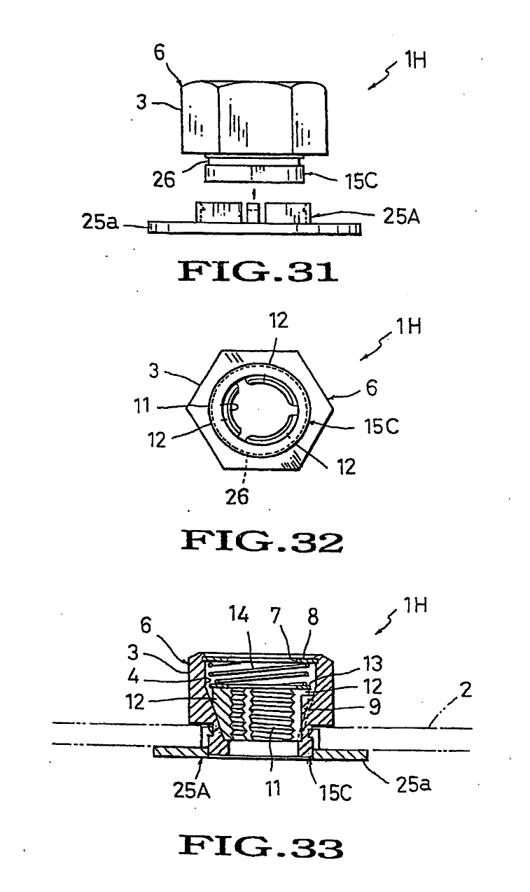

A ninth embodiment of the present invention is shown in FIGS. 31 to 33. It is distinguished from the first embodiment by the fact that the attachment part 15 is replaced from another similar attachment part 15C. The attachment part 15C has a fitting portion 26 provided at an outer circumferential portion thereof. The fitting portion 26 of the attachment part 15C is engaged with the attachment member 25A with the flange 25a by pressure. A nut 1H in this way according to the ninth embodiment has similar advantages to that according to the first embodiment.

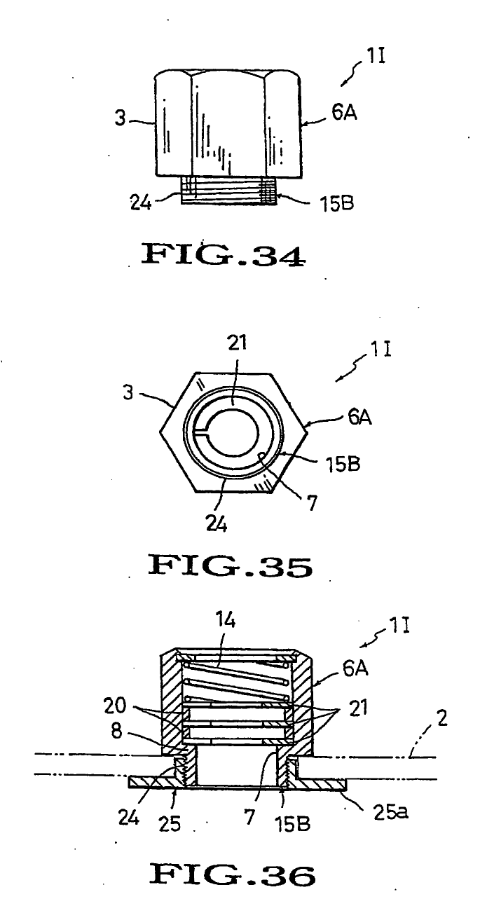

A tenth embodiment of the present invention is shown in FIGS. 34 to 36. It is distinguished from the third embodiment by the fact that the attachment part 15 is replaced from another similar attachment part 15B. The attachment part 15B has a thread portion 24 provided at an outer circumferential portion thereof. The thread portion 24 of the attachment portion is screwed onto a mounting member 25, having a flange 25a, formed in the shape of a nut. A nut 11 in this way according to the tenth embodiment has similar advantages to that according to the third embodiment.

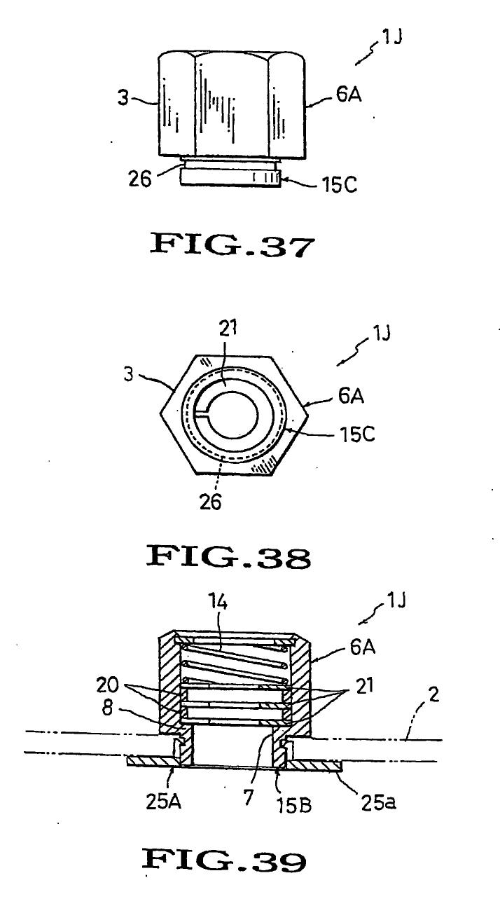

An eleventh embodiment of the present invention is shown in FIGS. 37 to 39. It is distinguished from the third embodiment by the fact that the attachment part 15 is replaced from another similar attachment part 15C. The attachment part 15C has a fitting portion 26 provided at an outer circumferential portion thereof. The fitting portion 26 of the attachment part 15C is engaged with the attachment member 25A with the flange 25a by pressure. A nut 1J in this way according to the eleventh embodiment has similar advantages to that according to the third embodiment.

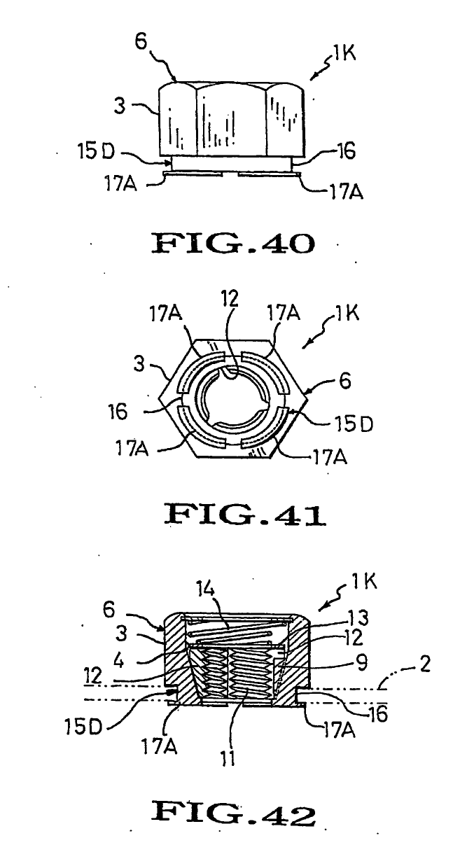

A twelfth embodiment of the present invention is shown in FIGS. 40 to 42. It is distinguished from the first embodiment by the fact that the attachment part 15 is replaced from another similar attachment part 15D. The attachment part 15D has integrally a plurality of fitting pieces, four fitting pieces 17A in the embodiment of the present invention, provided at an end thereof. A nut 1K with fitting piece 17A according to the twelfth embodiment has similar advantages to that according to the first embodiment.

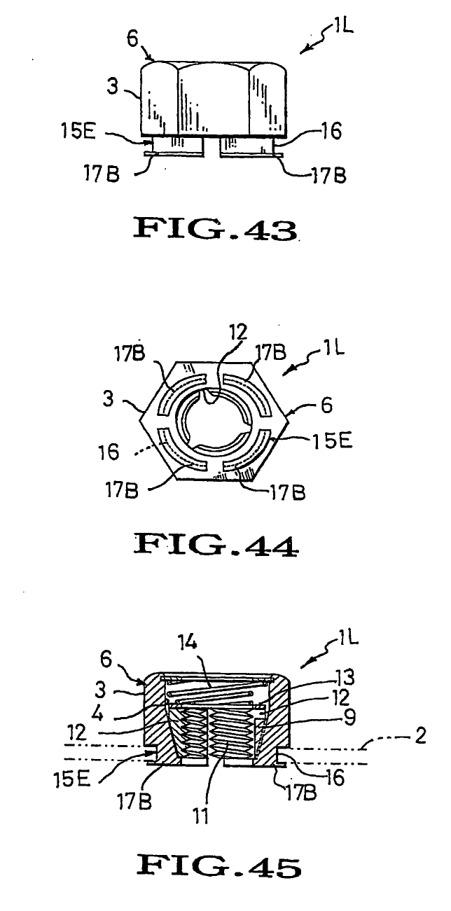

A thirteenth embodiment of the present invention is shown in FIGS. 43 to 45. It is distinguished from the twelfth embodiment by the fact that the attachment part 15 is replaced from another similar attachment part 15E. The attachment part 15E has a plurality of fitting pieces, four fitting pieces 17B in the embodiment of the present invention, provided at the small diameter of the nut body 6. In addition, the attachment part plays a role of the support axle. A nut 1L with fitting pieces 17B according to the thirteenth embodiment has similar advantages to that according to the twelfth embodiment.

Moreover, in each of the abovementioned embodiment of the present invention, the nut segments similar to nut segment 12 may be provided in a number greater than three.

Additionally, the nut member may be provided in a number greater than three.

As set forth above; the advantages of the invention are as follows:

(1) A nut comprises a nut body having an outer wall formed in the shape of a polygon and an inner wall defining said through hole including at least a portion thereof being an inclined wall hole having a diameter decreasing from a first diameter to a second diameter proximate said second end that is less than said first diameter; a stopper formed as a stop flange extending radially inward into said through hole at said first end of the nut body, the stopper including said stop flange defining a bolt exit aperture of said through hole; at least two guideposts formed coaxially on said inner wall of the nut body at said inclined wall hole; at least two nut segments being movably disposed between the guideposts so as to permit sliding movement in an axial direction and radial displacement urged by sliding engagement of said inclined outer surfaces with said inner wall at said inclined wall hole, each having an inner surface facing said axis of said through hole, said inner surface having a screw thread for engaging a thread of said bolt; a spring disposed in the nut body between said stop flange and said at least three nut segments to bias said at least three nut segments toward said second end of said nut body; said nut body including an attachment part provided adjacent said second end, one of said attachment part with a fitting piece in order to attach rotatably and prevent to remove fixedly to a member with an axle hole and another attachment part attached to said attachment member by one of screwing and pressure, so that it can be attached rotatably without removing so that the fitting piece of the attachment part fits to the attachment member.

Therefore, the attachment member has a function as a washer and fixing tool for the washer, it is easy to attach.

(2) As discussed above, the bolt can be pushed into the nut to a tightening position, and two or more nut segments can be screwed onto the thread portion of the bolt by rotating the nut body.

Therefore, Attachment is easily done and can carry out for a short time.

(3) As discussed above, since it is not necessary to attach a washer as before while it can manufacture easily and it can manufacture at low cost. Moreover, since the attachment part with a fitting piece is just formed at the nut body, manufacture is easily done.

1. A nut, comprising:
a body having an outer wall and an inner wall, said inner wall defining a through hole, at least a portion of said through hole being tapered and having an inner diameter decreasing from a first diameter at a first end to a second diameter proximate a second end that is less than said first diameter;
a stop extending radially inward into said through hole at said first end of the body, the stop defining a bolt exit aperture of said through hole;
at least two guides formed coaxially on said inner wall of the body at said inclined wall hole;
at least two nut segments being movably disposed between the guides so as to permit sliding movement in an axial direction and radial displacement urged by sliding engagement of said inclined outer surfaces with said inner wall at said inclined wall hole, each of said nut segments including an inner surface facing a central axis of said through hole, said inner surface having a screw thread for engaging a thread of a bolt received therein;
a spring disposed in the body between said stop and said at least two nut segments to bias said at least two nut segments toward said second end of said body;
an attachment part provided on said body adjacent said second end thereof which extends axially from said second end, said attachment part including at least one fitting piece in a position spaced apart from said second end and projecting radially outward from the attachment part; and
an attachment member having a hole for accommodating the attachment part, said at least one fitting piece engaging said attachment member in a manner in which said attachment member and said body are mutually retained one to another.
